(19) United States
(12) Patent Application Publication
(10) Pub. No.: US 2004/0125205 A1
(43) Pub. Date: Jul. 1, 2004

(54) System and a method for high speed three-dimensional imaging

(76) Inventor: Z. Jason Geng, Rockville, MD (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/728,393

(22) Filed: Dec. 4, 2003

Related U.S. Application Data
(60) Provisional application No. 60/431,611, filed on Dec. 5, 2002.

(51) Int. Cl. H04N 7/18; H04N 9/47

(52) U.S. Cl. 348/142

(57) ABSTRACT

A high speed 3D camera includes a monochromatic sensor configured to receive a reflected light pattern from an object to be photographed, a plurality of optical pattern filters configured to capture multiple separate sequential images of the object using the reflected light pattern, and a computing device configured to combine the sequential images to generate a single frame image of the object, wherein the single frame image provides sufficient information to generate 3D image of the object.

### RELATED APPLICATIONS

The present application claims priority under 35 U.S.C. § 119(e) from the following previously-filed Provisional Patent Application, U.S. Application No. 60/431,611, filed Dec. 5, 2002 by Geng, entitled “Methods and Apparatuses for High Speed Three Dimensional Imaging” which is incorporated herein by reference in its entirety.

### BACKGROUND

High-speed three-dimensional (3D) imaging is an increasingly important function in advanced sensors in both military and civilian applications. For example, high-speed 3D capabilities offer many military systems with greatly increased capabilities in target detection, identification, classification, tracking, and kill determination. As a further example, real time 3D imaging techniques also have great potential in commercial applications, ranging from 3D television, virtual reality, 3D modeling and simulation, Internet applications, industrial inspection, vehicle navigation, robotics and tele-operation, to medical imaging, dental measurement, as well as apparel and footwear industries, just to name a few.

A three dimensional surface profile imaging method and apparatus described in U.S. Pat. No. 5,675,407 (“the '407 patent”), the disclosure of which is incorporated herein by reference in its entirety, conducts imaging by projecting light through a linear variable wavelength filter (LVWF), thereby projecting light having a known, spatially distributed wavelength spectrum on the objects being imaged. The LVWF is a rectangular optical glass plate coated with a color-filtering film that gradually varies in color, (i.e., wavelength). If the color spectrum of a LVWF is within the visible light region, one edge of the filter rectangle may correspond to the shortest visible wavelength (i.e. blue or violet) while the opposite edge may correspond to the longest visible wavelength, (i.e. red). The wavelength of light passing through the coated color-filtering layer is linearly proportional to the distance between the position on the filter glass where the light passes and the blue or red edge. Consequently, the color of the light is directly related to the angle θ, shown in FIG. 1, at which the light leaves the rainbow projector and LVWF.

Referring to FIGS. 1 and 2 in more detail, the imaging method and apparatus is based on the triangulation principle and the relationship between a light projector (100) that projects through the LVWF (101), a camera (102), and the object or scene being imaged (104). As shown in FIG. 1, a triangle is uniquely defined by the angles theta (θ) and alpha (α), and the length of the baseline (B). With known values for θ, α, and B, the distance (i.e., the range R) between the camera (102) and a point Q on the object's surface can be easily calculated. Because the baseline B is predetermined by the relative positions of the light projector (100) and the camera (102), and the value of α can be calculated from the camera's geometry, the key to the triangulation method is to determine the projection angle, θ, from an image captured by the camera (102) and more particularly to determine all θ angles corresponding to all the visible points on an object's surface in order to obtain a full-frame 3D image in one snapshot.

FIG. 2 is a more detailed version of FIG. 1 and illustrates the manner in which all visible points on the object's surface (104) are obtained via the triangulation method. As can be seen in the figure, the light projector (100) generates a fan beam of light (200). The fan beam (200) is broad spectrum light (i.e., white light), which passes through the LVWF (101) to illuminate one or more three-dimensional objects (104) in the scene with a pattern of light rays possessing a rainbow-like spectrum distribution. The fan beam of light (200) is composed of multiple vertical planes of light (202), or “light sheets”, each plane having a given projection angle and wavelength. Because of the fixed geometric relationship among the light source (100), the lens of the camera (102), and the LVWF (101), there exists a one-to-one correspondence between the projection angle (θ) of the vertical plane of light and the wavelength (λ) of the light ray. Note that although the wavelength variations are shown in FIG. 2 to occur from side to side across the object (104) being imaged, it will be understood by those skilled in the art that the variations in wavelength could also be made from top to bottom across the object (104) or scene being imaged.

The light reflected from the object (104) surface is then detected by the camera (102). If a visible spectrum range LVWF (400-700 nm) is used, the color detected by the camera pixels is determined by the proportion of its primary color Red, Green, and Blue components (RGB). The color spectrum of each pixel has a one-to-one correspondence with the projection angle (θ) of the plane of light due to the fixed geometry of the camera (102) lens and the LVWF (101) characteristics. Therefore, the color of light received by the camera (102) can be used to determine the angle θ at which that light left the light projector (100) through the LVWF (101).

As described above, the angle α is determined by the physical relationship between the camera (102) and the coordinates of each pixel on the camera's imaging plane. The baseline B between the camera's (102) focal point and the center of the cylindrical lens of the light projector (100) is fixed and known. Given the value for angles α and θ, together with the known baseline length B, all necessary information is provided to easily determine the full frame of three-dimensional range values (x,y,z) for any and every visible spot on the surface of the objects (104) seen by the camera (102).

While the camera (102) illustrated in FIG. 2 effectively produces full frame three-dimensional range values for any and every visible spot on the surface of an object (104), the camera (102) also requires a high Signal-to-noise (S/N) ratio, a color sensor, and an LVWF (101) with precision spectral variation, all of which is expensive to achieve. Consequently, there is a need in the art for an inexpensive yet high speed three dimensional camera.

### SUMMARY

J A high speed 3D camera includes a monochromatic sensor configured to receive a reflected light pattern from an object to be photographed, a plurality of optical pattern filters configured to capture multiple separate sequential images of the object using the reflected light pattern, and a computing device configured to combine the sequential images to generate a single frame image of the object, wherein the single frame image provides sufficient information to generate 3D image of the object.

### BRIEF DESCRIPTION OF THE DRAWINGS

The accompanying drawings illustrate various embodiments of the present system and method and are a part of the specification. The illustrated embodiments are merely examples and do not limit the scope of the claims.

FIG. 1 is a simplified block diagram illustrating a triangulation principle used in the present system and method according to one exemplary embodiment.

FIG. 2 is a block diagram illustrating a number of components traditionally used in a Rainbow 3D camera according to one exemplary embodiment.

FIG. 3 is a simplified diagram illustrating a monochromatic camera receiving three variable intensity patterns according to one exemplary embodiment.

FIG. 4A is a simplified block diagram illustrating a 3D camera incorporating a sequential within frame time (SWIFT) concept according to one exemplary embodiment.

FIG. 4B is a chart illustrating a timing of the projection and exposure trigger of the 3D camera illustrated in FIG. 4A according to one exemplary embodiment.

FIG. 5A is a simplified block diagram illustrating a 3D camera incorporating a SWIFT concept according to one exemplary embodiment.

FIG. 5B is a chart illustrating a timing of the projection and exposure trigger of the 3D camera illustrated in FIG. 5A according to one exemplary embodiment.

FIG. 6 is an exploded view illustrating monochromatic pattern projection using an LED array according to one exemplary embodiment.

FIG. 7 is a simplified block diagram illustrating a system configured to acquire 3D images in real time using near infrared light according to one exemplary embodiment.

FIG. 8 is a side view illustrating the positioning of a high speed electronically controllable shutter according to one exemplary embodiment.

FIG. 9A is a simplified block diagram illustrating the acquisition of a 2D color image using a monochromatic sensor according to one exemplary embodiment.

FIG. 9B is a simplified block diagram illustrating the acquisition of a 2D color image using a monochromatic sensor according to one exemplary embodiment.

FIG. 10 is a simplified block diagram illustrating a system for acquiring a full coverage 3D image according to one exemplary embodiment.

Throughout the drawings, identical reference numbers designate similar but not necessarily identical elements.

### DETAILED DESCRIPTION

The present specification discloses a method for performing high speed three dimensional imaging using a monochromatic sensor. More specifically, a camera configuration is disclosed having a monochromatic sensor that receives light patterns produced by a monochromatic light projector. A number of methods are disclosed for using the present camera configuration to produce, among other things, a red green blue (RGB) color image, a three dimensional image, multiple exposures in a single frame, and full coverage three-dimensional images.

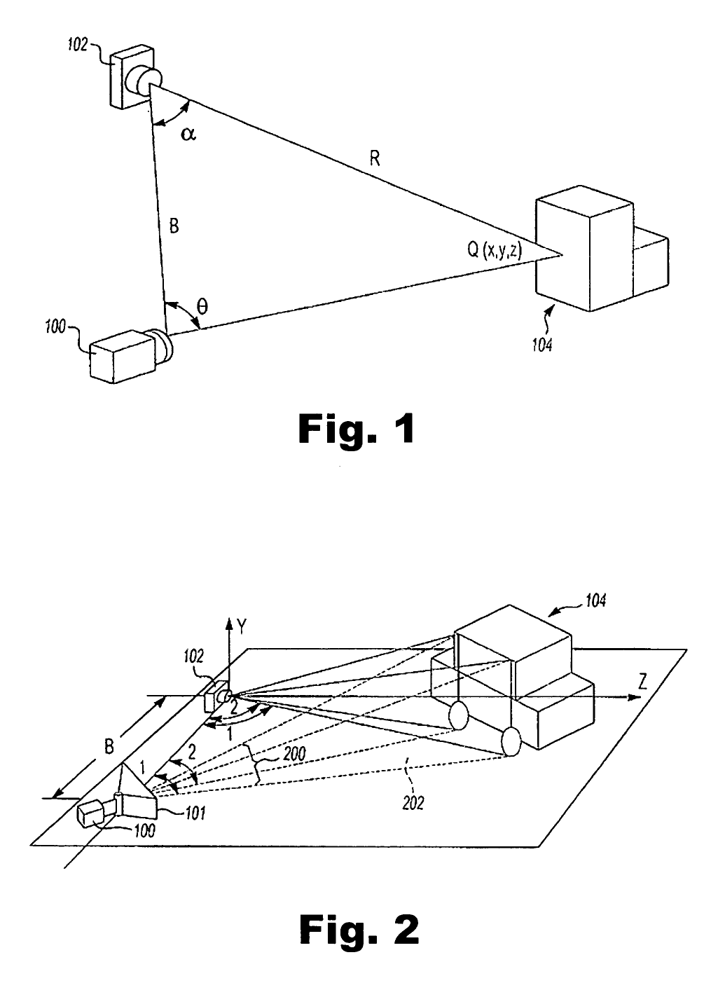

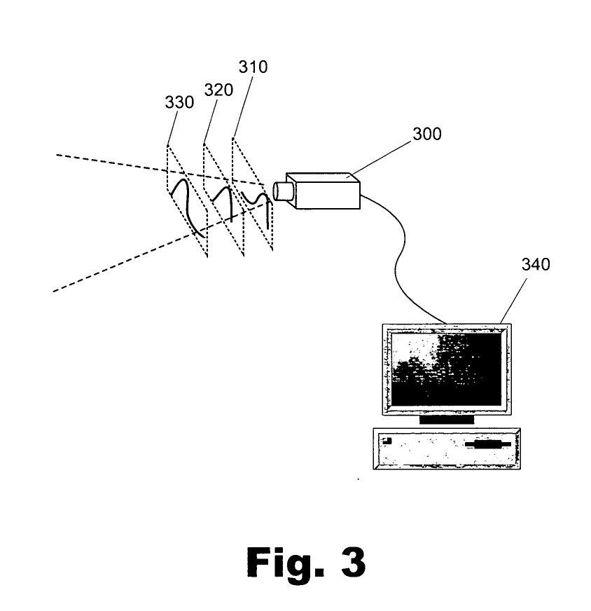

As used in the present specification and in the appended claims, the phrase “CCD” or “charge-coupled device” is meant to be understood as any light-sensitive integrated circuit that stores and displays the data for an image in such a way that each pixel (picture element) in the image is converted into an electrical charge, the intensity of which is related to a color in the color spectrum. Additionally, the term “trigger” is meant to be understood as an event or period of time during which a projection or sensing event is performed. “Cross-talk” refers to any interference between projection patterns, whether projected from a single projector or multiple projectors. Additionally the term “Philips prism” is a term of art referring to an optical prism having tilted dichroic surfaces. Also, the term “monochromatic” refers to any electromagnetic radiation having a single wavelength. The term “Rainbow-type image” or “Rainbow-type camera” is meant to be understood as an image or a camera configured to collect an image that may be used to form a three-dimensional image according to the triangulation principles illustrated above with respect to FIGS. 1 and 2.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Rainbow light traditionally used by the Rainbow 3D camera illustrated in FIG. 2 is a beam of broad-spectrum light (i.e., white light) which passes through a LVWF (101) to illuminate one or more three-dimensional objects (104) with a pattern of vertical planes of light (202); each plane having a given projection angle and wavelength. In order to collect the reflection of the rainbow projection from the object surface, a color CCD camera was traditionally used. The variation in the sensed spectrum was determined by the ratio of Red, Green, and Blue (RGB) components of each pixel in a color image acquired by the CCD camera.

Rather than follow the traditional methods of using a relatively expensive RGB sensor to capture a color spectrum image, one exemplary embodiment illustrated in FIG. 3 uses a monochromic CCD camera (300) having red, green, and blue filters to capture three separate images, one for each color, and integrate these three images into an RGB color image. Moreover, to further reduce the cost of the present system and method, a monochromatic light projector configured to transmit three variable intensity patterns similar to the spectral characteristics of the RGB filters of the present CCD camera is used.

As shown in FIG. 3, a camera (300) that implements the teachings of the rainbow 3D camera while using a monochromatic sensor receives three sequential light projections (310, 320, 330), each having a variable intensity pattern similar to the spectral characteristics of the RGB filter. Once the three sequential light pattern projections (310, 320, 330) are received by the camera (300), they are transferred to a communicatively coupled computing device (340) or other pattern combination means configured to combine the three monochromatic images received by the camera (300) to obtain a one frame image that is equivalent to that of the above mentioned Rainbow projection. The computing device (340) may host an application such as a mosaic program configured to combine the three monochromatic images into a one frame image.

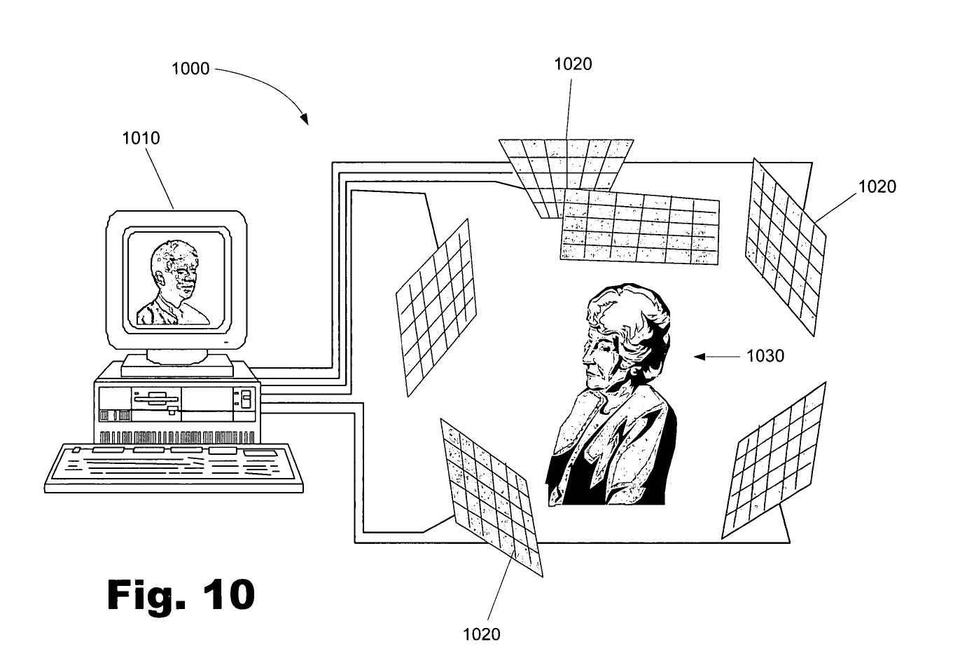

By using the configuration of FIG. 3, the costly CCD sensor and LVWF may be eliminated without sacrificing accuracy of the 3D images. More importantly, the configuration illustrated in FIG. 3 facilitates a narrow-band projection and image acquisition for each sensor employed. Accordingly, simultaneous acquisition of multiple 3D images from different views using multiple monochromatic 3D sensors with different spectral wavelengths is possible as will be further described with reference to FIG. 10 below.

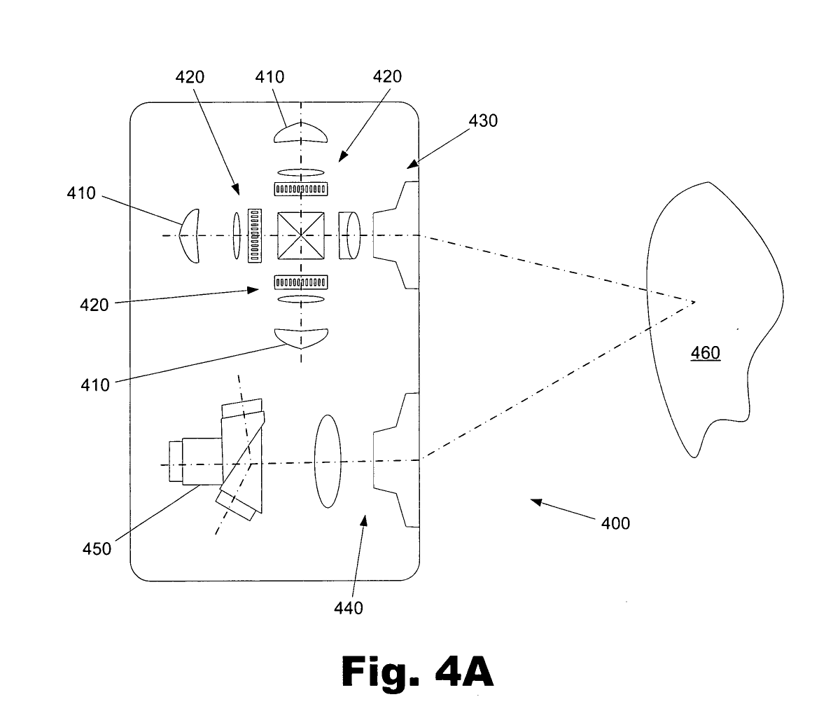

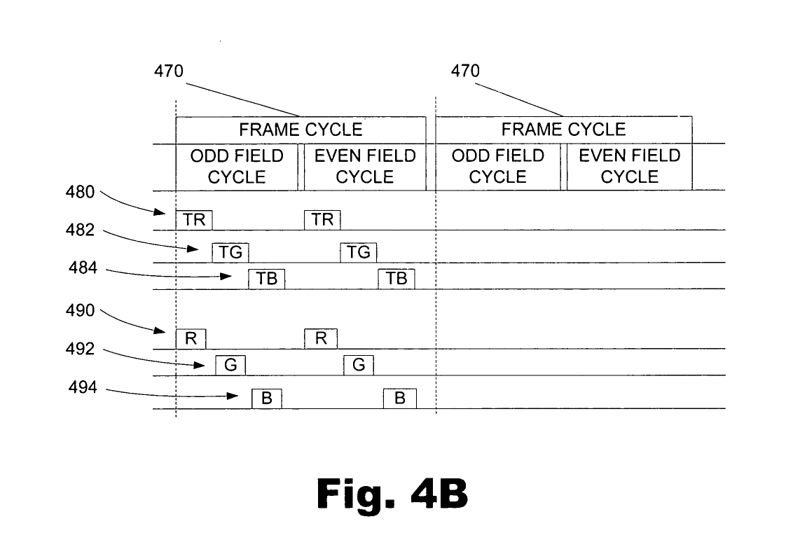

FIG. 4A illustrates a 3D imaging system (400) configured to image a three-dimensional object (460) using a 3CCD sensor and monochromatic light produced by three light emitting diodes (LEDs) (410). As shown in FIG. 4A, the imaging system (400) may include a projection portion including a plurality of light sources (410) such as LEDs, light projection patterns (420), and projection optics (430). The imaging system (400) also includes an imaging portion including imaging optics (440) and a 3CCD sensor (450).

The plurality of light sources (410) illustrated in FIG. 4A may include 3 LEDs, each emitting different spectrum bands. LED technology has made rapid advances in recent years, partly fused by the demands from optical telecommunication industry. Recent development of high-brightness LED materials has opened a variety of rapidly growing applications for LEDs. Materials used in producing the LEDs of FIG. 4A may include, but are in no way limited to, AlGaAs (red), InGaAlP (yellow-green through red), and InGaN (blue, green, and white). Similarly, the LEDs may include, but are in no way limited to, leaded or surface-mount package types. As projection light sources, LEDs have several distinguished advantages including: 1. extremely high lighting efficiency (very low current draws (approx. 0.1 A) vs. several Amps for halogen lamps); 2. nanosecond level of switching speed: unlike halogen or metal halide lamps which have thermal warming up periods to reach steady status of light illumination, LEDs can switch on and off, and control brightness very rapidly (in the nanosecond level); 3. LEDs provides a narrow spectrum band (in the region of 30 nanometer bandwidth versus traditional wideband white light projection); 4. Fast response time—nanoseconds vs. seconds for halogen lamps (by synchronizing with CCD/Complementary Metal Oxide Semiconductor (CMOS) sensor acquisition timing, such fast-responded projection device can achieve very strong projections while making them virtually undetectable by subjects due to slow response time of the human eye); and 5. life span: 100,000 hours versus the typical 1000 hours for halogen lamps. Additionally the timing of the LEDs for illumination can be easily coupled with high speed trigger signals in the corresponding sensor channels as will be discussed in further detail below with reference to FIG. 4B. The light projection patterns (420) used in conjunction with the LEDs or other light sources (410) can use monochromic light and can be designed independently to maximize the light output.

The projection optics (430) illustrated in FIG. 4A may include any number of lenses, mirrors, or beam splitters commonly used in the art. Similarly, the imaging optics illustrated in FIG. 4A may include a number of lenses and mirrors commonly known in the art that may be used to focus a received image onto the 3CCD sensor (450).

The 3 CCD sensor (450) illustrated in FIG. 4A is a sensor including three charge-coupled devices (CCDs). A CCD is a light-sensitive integrated circuit that stores and displays the data for an image in such a way that each pixel (picture element) in a received image is converted into an electrical charge, the intensity of which is related to a color in the color spectrum. The CCD sensors (450) illustrated in FIG. 4A may have a frame rate as high as 120 frames per second (fps) or higher, thereby facilitating the acquisition of images at a rate of 30 fps. While the embodiment illustrated in FIG. 4A is described in the context of incorporating 3 CCD sensors, any number or type of light sensing sensors may be used. According to one exemplary embodiment, two sensors may be used to produce a three-dimensional image.

During operation of the imaging system (400) illustrated in FIG. 4A the LEDs (410) sequentially project light sources, each having varying spectrum bands due to the light projection patterns (420). The light sources are projected by the projection optics (430) and reflected off of a three-dimensional object (460). Once reflected, the imaging optics (440) collect the reflected images which are then sensed by the 3CCD sensor (450) to produce a three-dimensional image. The challenge of the sequential projection approach described above is the reduced imaging speed. By projecting three separate light projections, three separate image frames have to be taken in order to obtain a single frame 3D image. In order to increase imaging speed, three independent R, G, B frames are obtained within a single frame cycle (at normal video rate) using the 3 chip CCD sensors (450) as shown in FIG. 4B. This method not only increases the imaging speed, but it also eliminates the effect of multi-frame crosstalk.

Traditional 3-chip CCD sensors use a single “exposure trigger” signal line for all 3 CCD sensors. An exposure trigger is a period of time wherein a light projection is exposed to its corresponding sensor channel. Images with all three colors were traditionally taken during the same exposure period. This of course creates the possibility of crosstalk among these channels. Crosstalk occurs when multiple components of light exposure contribute to a single component channel. For example, the output of the Red channels will not only be contributed to by the red component of the light exposure, but also the “crosstalk” from blue spectrum due to the spectrum sensitivity curve of the red sensor. The fundamental reason for the crosstalk is the fact that multiple channels of lighting pattern are shined to the sensor simultaneously. If these lighting patterns are projected in a sequential fashion within the same field cycle, the crosstalk problem can be resolved.

FIG. 4B illustrates an implementation of a sequential within frame time (SWIFT) concept according to one exemplary embodiment. As illustrated in FIG. 4B, rather than using single exposure trigger timing, a plurality of timing trigger circuits are used to produce separate and independent exposure trigger signals (480, 482, 484) for red, green, and blue channels. These trigger signals TR (480), TG (482), and TB (484) are synchronized with their corresponding light source/structural pattern projections for Red (490), Green (492), and Blue (494) strobe channels. The trigger signals corresponding to sensor exposure (480, 482, 484) as well as the light source projections (490, 492, 494) can be overlapping or non-overlapping, depending on the tolerance of different channels for being affected by crosstalk. For example, if red (480) and green (482) channel have little crosstalk, they can be controlled to be exposed simultaneously. On the other hand, if red (482) and blue (484) have severe crosstalk, then their timing should be arranged sequentially to eliminate the possible crosstalk effect.

More importantly, the duration of these trigger signals TR (480), TG (482), and TB (484) can be controlled independently to accommodate the CCD sensitivity, object reflectivity for different surface colors, and illumination source variations. The light source/structural pattern projections for red (490), green (492), and blue (494) channels will be controlled accordingly to synchronize with the exposures of their corresponding channels.

By synchronizing the projection and exposure trigger signals as illustrated above, high image collection rates may be achieved. The above-mentioned synchronization methods facilitate three-dimensional imaging acquisition at typical video rates (30 frames per second). Additionally, the exposure time for each exposure trigger can be much shorter (e.g. 1/2000 sec.) than the 1/30 of a second frame cycle (470) allowing all of the exposures for different channels to be performed within a single frame cycle (470). Moreover, because the projection and exposure trigger signals may be sequentially synchronized, crosstalk issues may be eliminated and the design of the multi-spectrum projection mechanism may be simplified.

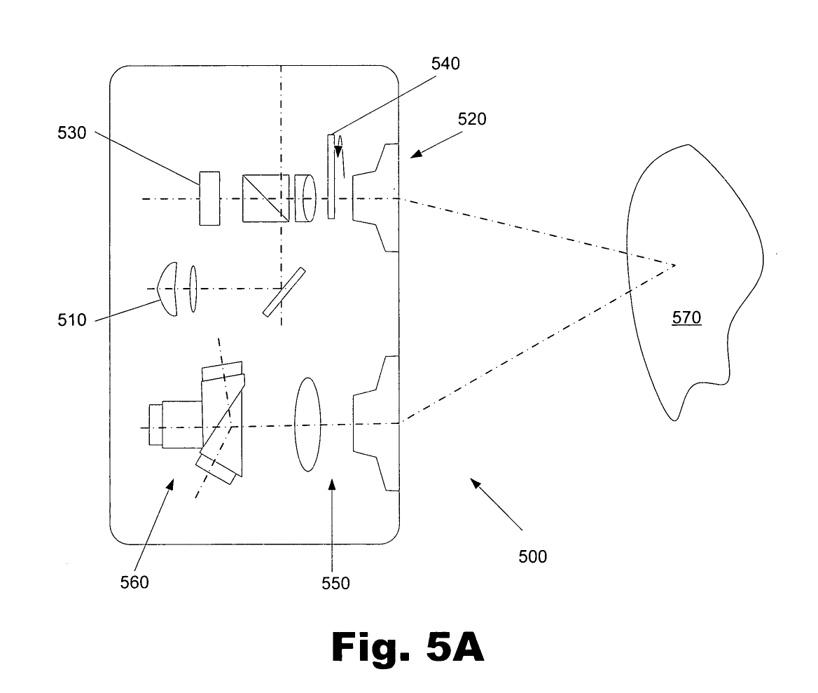

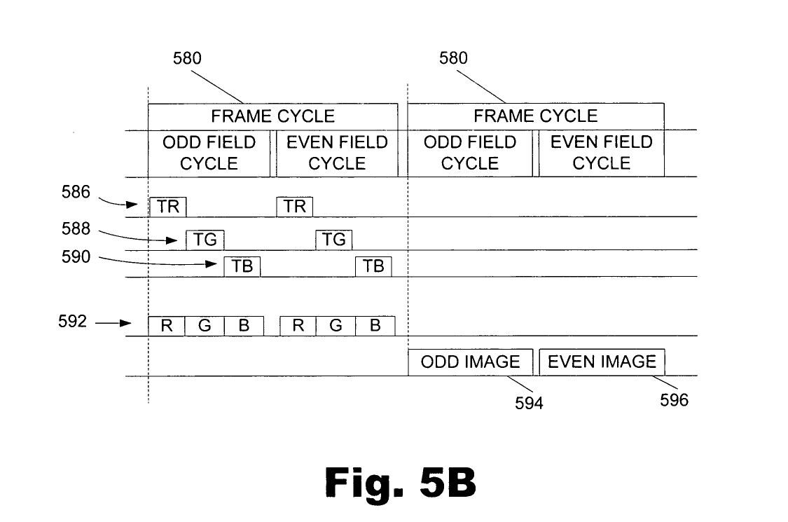

In an alternative embodiment illustrated in FIG. 5A, high speed 3D surface imaging can be accomplished using the SWIFT method and a 3CCD sensor (560) in conjunction with a sequential color projector. As shown in FIG. 5A, The SWIFT 3CCD sensors (560) may be synchronized with a traditional video projector system to form a 3D imaging system (500). As shown in FIG. 5A, one exemplary embodiment of a high speed 3D imaging system (500) for imaging a three-dimensional object (570) includes the traditional components of a video projector system such as a light source (510), projection optics (520), a deformable mirror or LCD (530), and a color wheel (540). These components are used to project onto the three-dimensional object (570) being imaged. The imaging portion of the 3D imaging system includes imaging optics (550) and a 3CCD sensor (560).

As shown in FIG. 5A, a light source (510) produces light which is then transmitted through a number of projection optics (520) including lenses, mirrors, and/or a polarizing beam splitter. The light may then be sequentially varied using a deformable mirror or an RGB LCD (530) in connection with a color wheel (540) using traditional projector switching technology. According to one exemplary embodiment, the switching frequency of the traditional video projector is 30 frames per second (fps); however, projectors with other frequencies can also be used according to the same principles. While the various color projections are sequentially projected, they reflect off of a three-dimensional object (570) and are then received by the imaging optics (550). As the image projections are sequentially received by the imaging optics (550), they are sequentially sensed and collected by the 3CCD sensor (560). Once collected, the image projections may be used to produce a three-dimensional image according to the 3D imaging methods described above.

FIG. 5B illustrates a method for using the color generation mechanism of the video projector to perform sequential color projection within a single frame cycle time using the SWIFT concept. As shown in FIG. 5B, the timing of the color generation (592) performed by the video projector may be synchronized with the timing of the SWIFT sensor exposure (586, 588, 590). The timing is synchronized to match the exposure of the red CCD (586) with the red projection, the exposure of the green sensor (588) to the green projection, and the exposure of the blue sensor (590) to the blue projection. By so synchronizing the color generation and the sensor exposure, crosstalk between different color channels can be eliminated and three clean frames of image with corresponding projection patterns can be produced. These clean frames of image may then be used to generate both odd (594) and even (596) 3D images.

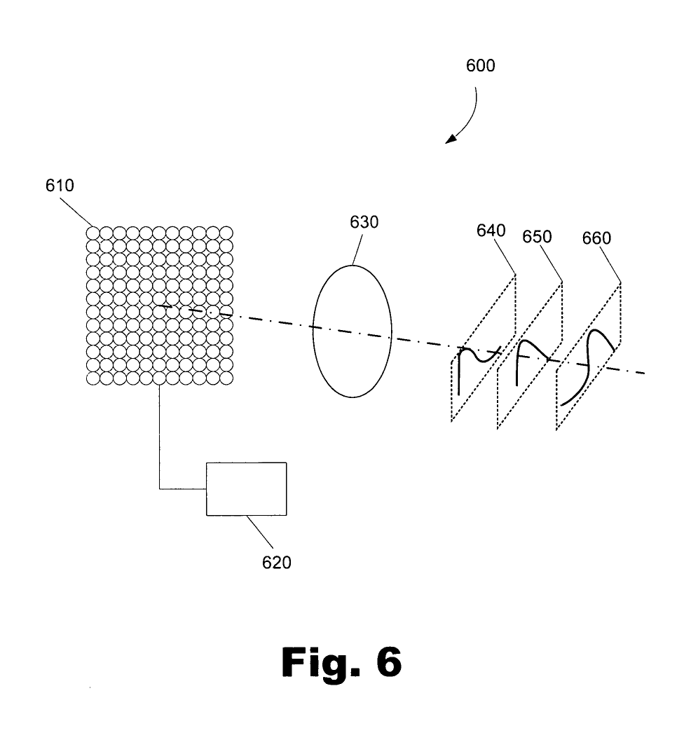

In addition to the video projectors previously mentioned, an array of LEDs (610) can be economically built to produce narrow-band pattern projections (640, 650, 660) as illustrated in FIG. 6. As shown in FIG. 6, a 3D imaging system (600) may include an array of closely spaced RGB LEDs (610) formed in a video projector. The spacing of the LEDs (610) may vary depending on the desired projection patterns. The LEDs (610) are coupled to a number of electronic drivers (620) that selectively control the projection of narrow-band pattern projections (640, 650, 660), through projection optics (630) similar to those described above, and onto a three-dimensional object. By controlling the LED array (610) with the electronic drivers (620), the narrow-band pattern projections (640, 650, 660) can be suited to facilitate imaging according to the 3D imaging systems illustrated above. The driver electronics (620) may control and sequentially vary the intensity of each vertical column of LEDs. To that end, the driver electronics (620) can include a memory device that pre-stores several designed patterns and perform quick switches among them in the sequential projection operations. Once the narrow-band pattern projections (640, 650, 660) are reflected from the three-dimensional object, they may be sequentially received by imaging optics (550; FIG. 5) and sequentially sensed and collected by a 3CCD sensor (560; FIG. 5) according to the above-mentioned SWIFT concept. While the above illustrated example includes varying the intensity of each vertical column of LEDs, the controlled variation of the LEDs may occur on a horizontal row basis or any other desired pattern.

The driver electronics (620) illustrated in FIG. 6 may also synchronize the projection timing of the LEDs with any number of imaging sensors (CCDs or CMOSs) to achieve a desired optical performance. One of the issues in traditionally structured light 3D imaging systems is that they typically required high brightness to achieve acceptable accuracy. Bright lighting on human faces often affects the comfort level of the human subject. Using the fast response advantage of the LEDs, strong illumination can be projected in a very short amount of time, as short as 1/1000 of a second in one exemplary embodiment. This strong illumination can be synchronized with the timing of an imaging sensor to obtain an acceptable image according to the present SWIFT system and method. Moreover, the strong illumination in such a short period of time produced by the 3D imaging system (600) illustrated in FIG. 6 will not be felt by human subjects or cause any harm to the human subjects due to the slow response time of human eyes.

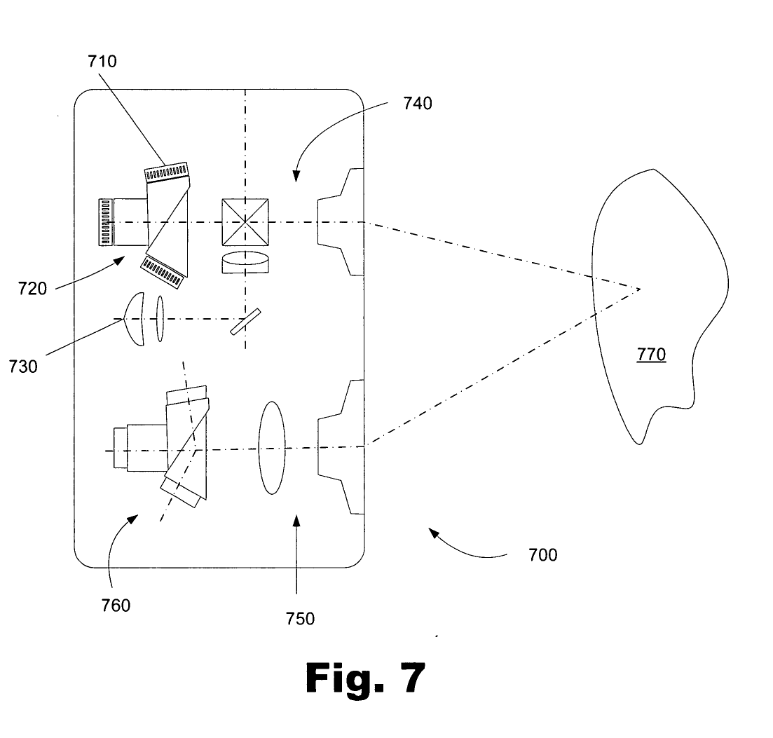

While the use of the LED array (610) illustrated in FIG. 6 allows for non-recognizable illumination in very short bursts, a number of uses desire an imaging system that can continuously acquire 3D images in real-time without projecting visible light onto the subject and without being affected by ambient visible illumination. FIG. 7 illustrates an exemplary system that may be used to acquire 3D images in real-time without projecting visible light on the subject according to one exemplary embodiment. As shown in FIG. 7, an exemplary 3D imaging system (700) is equipped with a near infrared (NIR) Rainbow light source (730) such as a halogen lamp with a long pass filter, a plurality of mirrors with a saw-tooth reflection pattern (710), Philips prisms (720), and other projection optics (740) including a polarizing beam splitter. Similarly, the imaging portion of the 3D imaging system (700) illustrated in FIG. 7 includes imaging optics (750) such as lenses and Philips prisms as well as three NIR CCD sensors (760). Because identical Philips prisms may be used in both the sensors (760) and the light source optics, design and production costs of the NIR 3D imaging system (700) illustrated in FIG. 7 are reduced.

Using the configuration illustrated in FIG. 7, matching spectrum bands between the 3CCD sensor (760) and the light source (730) is facilitated by the fact that both the projection and the imaging are performed using identical prisms. Additionally, any number of wavelengths from the NIR spectrum may be used, as long as three bands can be separated, and sawtooth intensities are generated by three identical “mirror gratings,” with ⅓ phase shift.

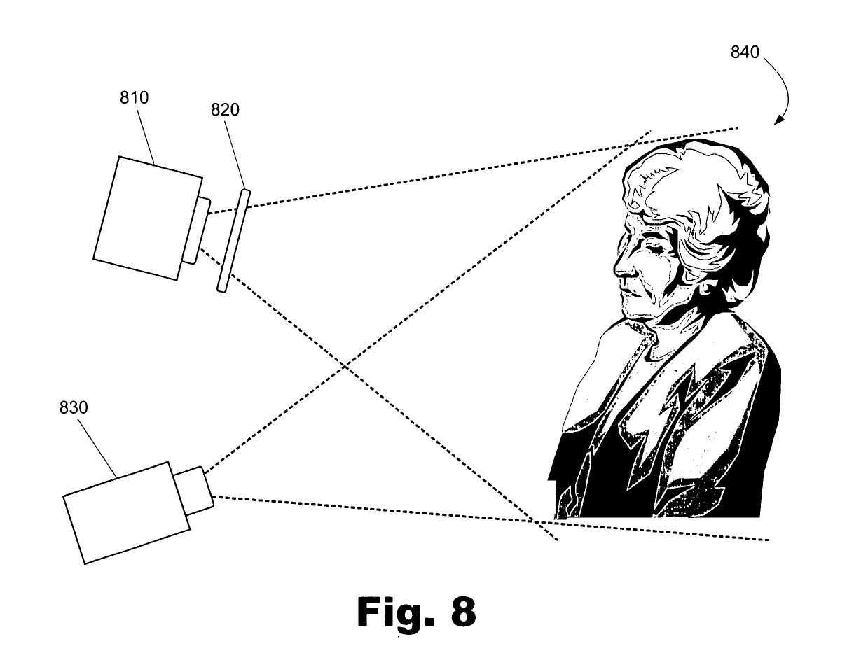

In order to further facilitate the timing of the SWIFT and other 3D imaging systems described above, any of the 3D image acquisition systems may include a high speed shutter (820) optically coupled to the video projector (810) as shown in FIG. 8. As shown in FIG. 8, a high speed shutter (820) may be placed between a video projector (810) and a three-dimensional object that is to be imaged (840). As the video projector (810) illuminates the object that is to be imaged (840), the high speed shutter (820) controls the timing of the pattern projection. Both the ON/OFF timing and the transmission rate of the high speed shutter (820) are electronically controllable. Consequently, the high speed shutter (820) may be used both to control the light intensity of the illumination from the video projector (810) and control the timing of the pattern projection to match the sensor trigger channels of the sensors disposed in the image sensor (830).

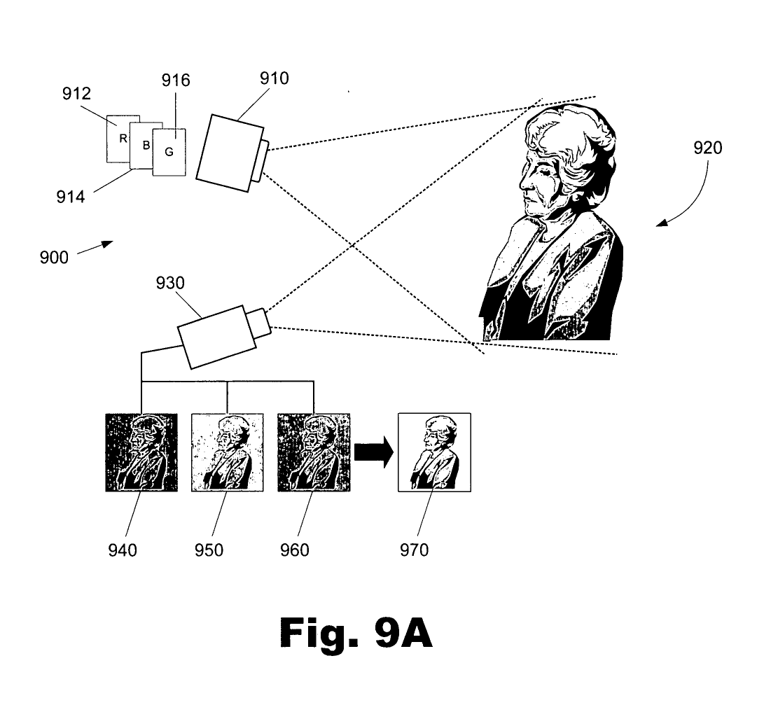

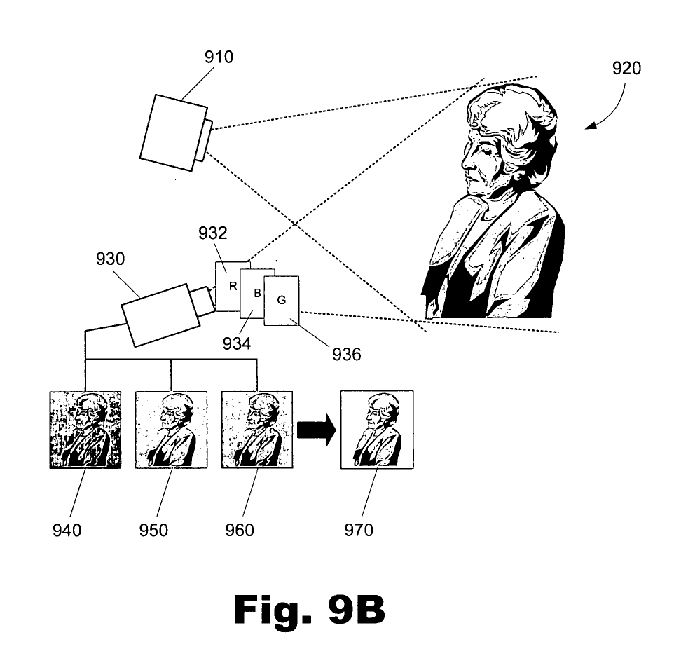

According to one alternative embodiment, the above-mentioned 3D imaging systems may be used to acquire both two-dimensional color images and three-dimensional images using the same monochromatic sensor. As shown in FIG. 9A, a two-dimensional color image (970) may be acquired by projecting sequential red (912), blue (914), and green (916) projections from the projector (910). As each color projection (912, 914, 916) is projected onto the object to be imaged (920), the single monochromatic sensor (930) acquires three sequential images (940, 950, 960), each corresponding to one of the sequential color projections (912, 914, 916). Once the three sequential images (940, 950, 960) are acquired by the monochromatic sensor (930), the three sequential images are combined to form a full color 2D image (970). This acquisition of a full color 2D image may be used in conjunction with the 3D imaging methods discussed above. Additionally, while the above-mentioned method was illustrated using sequential red (912), blue (914), and green (916) projections, any other desired combinations of colors may similarly be projected onto the object to be imaged (920) and combined to form a single two-dimensional image.

Similar to the embodiment illustrated in FIG. 9A, a 2D color image may be acquired by associating a plurality of filters (932, 934, 936) with the monochromatic sensor (930). According to this exemplary embodiment, a projector (910) projects monochromatic light onto an object to be imaged (920). As the reflected image is received by the monochromatic image sensor (930), a color filter wheel or electronic color tunable filter having a plurality of filters (932, 934, 936) is placed in front of the monochromatic image sensor. As a desired object is illuminated, three sequential images are acquired using three different color filters (932, 934, 936) in front of the sensor. According to one exemplary embodiment, the three different filters (932, 934, 936) include a red filter, a green filter, and a blue filter configured to produce corresponding sequential images (940, 950, 960) that may then be combined to form a full color 2D image. Once the three sequential images are acquired, they may be used as the RGB (or other color) illuminations for the RGB channels of a full color image (970). Consequently, the above-mentioned systems and methods illustrated in FIGS. 9A and 9B may be used according to the SWIFT concept teachings above to produce both a three-dimensional image and a full color two-dimensional image in a single frame.

According to yet another alternative embodiment, the above mentioned methods and apparatuses may be used to acquire a full coverage 3D image of a desired object. In order to acquire a full coverage 3D image of a desired object, a “snapshot” instant acquisition of multiple images from different views must be performed. The primary challenge of implementing such a system is that the operations of multiple 3D cameras often interfere with one another. In other words, the projection patterns of one camera can often be seen and detected by a second camera (known as crosstalk). This crosstalk can seriously affect the 3D imaging functions of each camera.

In order to remedy the potential crosstalk problems associated with full coverage of a 3D image using multiple cameras, a matched narrow-band spectral filter may be placed in front of each CCD sensor (1020) causing each 3D camera to function at a pre-designed wavelength range. As shown in FIG. 10, a system (1000) is presented including multiple 3D cameras having sensors (1020) with different non-overlapping bandwidths positioned around an object to be imaged (1030). Each sensor (1020) may collect 3D data regarding the object to be imaged (1030) from different views using the above-mentioned high speed imaging methods. For example, once the object to be imaged (1030) is positioned, multiple light patterns may be simultaneously projected onto the object to be imaged and the sensor (1020) of each 3D camera may then simultaneously acquire images without interfering with each other. According to the teachings previously mentioned, each sensor (1020) may use a different bandwidth to eliminate crosstalk between images, similar to dense wavelength division multiplexing (DWDM). Once acquired, the images may then be routed to a computing device (1010) where they are compiled to form a full surface image.

In conclusion, the present system and method for high speed three-dimensional imaging produces a three-dimensional image having the accuracy of a rainbow type image. Moreover, the three-dimensional image produced according to the present system and method is collected without the use of an expensive LVWF or a color sensor. Rather, the present system and method incorporates a monochromatic projector and a monochromatic sensor. Additionally, the present system and method facilitates the collection of the three-dimensional images by synchronizing the trigger signals, enabling image collection at rates over 30 fps. High image collections rate may be further enhanced by utilizing an LED array configured to project light undetecable by a human subject.

The above-mentioned system and method also allow for the collection of 3D images using a NIR rainbow light source. This system will allow the collection of accurate 3D image data using a light source undetectable by a human subject.

The preceding description has been presented only to illustrate and described embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A high speed 3D camera comprising:
a monochromatic sensor configured to receive a reflected light pattern from an object to be photographed;
a plurality of optical pattern filters configured to capture multiple separate sequential images of said object using said reflected light pattern; and
a computing device configured to combine said sequential images to generate a single frame image of said object;
wherein said single frame image provides sufficient information to generate 3D image of said object.

2. The high speed 3D camera of claim 1, wherein said plurality of optical pattern filters comprise color filters.

3. The high speed 3D camera of claim 2, wherein said plurality of color filters comprises primary color filters, wherein said plurality of color filters includes one filter for each primary color.

4. The high speed 3D camera of claim 3, wherein said plurality of optical pattern filters are configured to capture 3 separate sequential images of said object using said reflected light pattern.

5. The high speed 3D camera of claim 1, wherein said plurality of optical pattern filters comprise monochromatic pattern filters.

6. The high speed 3D camera of claim 5, wherein said plurality of optical pattern filters are configured to capture 2 separate sequential images of said object using said reflected light pattern.

7. The high speed 3D camera of claim 1, wherein said single frame image is substantially equivalent in quality to a Rainbow-type image of said object.

8. The high speed 3D camera of claim 1, further comprising a monochromatic light projector configured to generate a plurality of variable intensity pattern sequences similar to a spectral characteristic of said monochromatic sensor.

9. The high speed 3D camera of claim 8, wherein said multiple separate sequential images are captured within a single frame cycle.

10. The high speed 3D camera of claim 9, further comprising:
a plurality of timing trigger circuits communicatively coupled to said monochromatic sensor, wherein said plurality of timing trigger circuits are configured to generate a plurality of separate independent expose trigger signals associated with a plurality of independent trigger signals of said monochromatic light projector.

11. The high speed 3D camera of claim 10, wherein said monochromatic light projector further comprises a high speed electronically controllable shutter.

12. The high speed 3D camera of claim 8, further comprising:
a plurality of monochromatic sensors disposed around an object; and
a plurality of monochromatic light projectors associated with said plurality of monochromatic sensors;
wherein each of said monochromatic sensors operates in a unique spectrum band;
said camera being configured to simultaneously acquire a multi-view 3D image of said object.

13. The high speed 3D camera of claim 1, further comprising a means for projecting sequential color projections, wherein said means for projecting sequential color projections comprises one of a rotatable color wheel, a deformable mirror, or a sequential RGB light emitting diode array.

14. A high speed 3D camera comprising:
a monochromatic sensor configured to receive a reflected light pattern from an object to be photographed;
a plurality of color filters configured to capture three separate sequential images of said object using said reflected light pattern; and
a computing device configured to combine said sequential images to generate a single frame image of said object;
wherein said single frame image is substantially equivalent in quality to a Rainbow-type image of said object.

15. The high speed 3D camera of claim 14, wherein said plurality of color filters comprises primary color filters, wherein said plurality of color filters includes one filter for each primary color.

16. The high speed 3D camera of claim 14, further comprising a monochromatic light projector configured to generate three variable intensity pattern sequences similar to a spectral characteristic of said monochromatic sensor.

17. The high speed 3D camera of claim 16, wherein said three separate sequential images are captured within a single frame cycle.

18. The high speed 3D camera of claim 17, further comprising:
a plurality of timing trigger circuits communicatively coupled to said monochromatic sensor, wherein said plurality of timing trigger circuits are configured to generate separate independent expose trigger signals associated with independent trigger signals of said monochromatic light projector.

19. The high speed 3D camera of claim 18, wherein said monochromatic light projector further comprises a high speed electronically controllable shutter.

20. The high speed 3D camera of claim 14, wherein said computing device further comprises a mosaic means configured to combine said three separate sequential images to form a full color 2D image.

21. The high speed 3D surface image camera of claim 14, further comprising a means for projecting sequential color projections, wherein said means for projecting sequential color projections comprises one of a rotatable color wheel, a deformable mirror, or a sequential RGB light emitting diode array.

22. A Rainbow-type 3D camera comprising:
a light source;
a multiple light projection pattern generator associated with said light source for generating multiple substantially identical mirror-like gratings for sequential transmission to illuminate an object to be photographed;
projection optics for projecting said projection patterns towards said object to be photographed;
imaging optics for focusing reflected radiation patterns from said object towards an imaging sensor; and
a sensor array including a plurality of imaging sensors.

23. The 3D camera of claim 22, wherein said projection pattern generator comprises a plurality of mirrors, each of said plurality of mirrors configured to generate a predetermined reflection pattern.

24. The 3D camera of claim 23, wherein said projection pattern generator comprises a plurality of mirror gratings, each of said plurality of mirror gratings having a predetermined phase shift characteristic.

25. The 3D camera of claim 22, wherein the spectral bands of said imaging sensors and said light source are matched.

26. The NIR 3D camera of claim 22, wherein said projection optics further comprises a high speed electronically controllable shutter.

27. A near infra red (NIR) Rainbow-type 3D camera comprising:
an NIR light source;
a multiple light projection pattern generator for generating multiple substantially identical mirror-like gratings for sequential transmission to illuminate an object to be photographed;
projection optics for projecting said projection patterns towards said object to be photographed;
imaging optics for focusing reflected radiation patterns from said object towards an NIR sensor; and
a sensor array including a plurality of NIR imaging sensors.

28. The NIR 3D camera of claim 27, wherein said projection pattern generator comprises a plurality of mirrors, each of said plurality of mirrors configured to generate a predetermined reflection pattern.

29. The NIR 3D camera of claim 28, wherein said projection pattern generator comprises a plurality of mirror gratings, each of said plurality of mirror gratings having a predetermined phase shift characteristic.

30. The NIR 3D camera of claim 27, wherein the spectral bands of said NIR imaging sensors and said NIR light source are matched.

31. The NIR 3D camera of claim 27, wherein said projection optics further comprises a high speed electronically controllable shutter.

32. A high speed 3D surface imaging camera comprising:
a light projector for selectively illuminating an object to generate 3D image data;
an image sensor configured to receive reflected light from said object and to generate three separate color image data sets based on said reflected light; and
means for generating sequential color projections from said projector onto said object to be photographed;
wherein said image sensor is configured to eliminate cross talk between said sequential color projections by allowing for a sequential exposure of said image sensor within a single frame cycle, said sequential exposure corresponding with said sequential color projections.

33. The high speed 3D surface imaging camera of claim 32, wherein said image sensor comprises a plurality of charge-coupled device (CCD) sensors.

34. The high speed 3D surface imaging camera of claim 33, wherein said plurality of CCD sensors comprises 3 CCD sensors.

35. The high speed 3D surface imaging camera of claim 32, further comprising a computing device communicatively coupled to said image sensor wherein said computing device is configured to combine said separate color image data sets into a composite Rainbow-type image of said object.

36. The high speed 3D surface image camera of claim 32, wherein said means for projecting sequential color projections comprises one of a rotatable color wheel, a deformable mirror, or a sequential RGB light emitting diode array.

37. The high speed 3D surface image camera of claim 36, further comprising:
an array of closely spaced light emitting diodes configured to generate a high density projection pattern; and
driver electronics communicatively coupled to said array of closely spaced light emitting diodes, wherein said driver electronics are configured to synchronize a projection pattern of light from said light emitting diodes with said image sensor to achieve optical quality performance.

38. The high speed 3D surface image camera of claim 37, wherein said array of closely spaced light emitting diodes is further configured to project said high density projection pattern for a time period not detectible by human eyes.

39. The high speed 3D surface image camera of claim 38, wherein said time period not detectible by human eyes comprises less than 1/1000 of a second.

40. A color camera comprising:
a light projector for projecting sequential light patterns toward an object to be photographed;
a monochromatic sensor to acquire three sequential monochromatic images as the object is illuminated sequentially by said light projector; and
mosaic means for combining the three monochromatic images to form a composite images from sequential light patterns to form a full color 2D image.

41. The color camera of claim 40, wherein said sequential light patterns comprise a red, a green, and a blue light pattern.

42. The color camera of claim 40, wherein said monochromatic sensor is configured to collect said three sequential monochromatic images in a single frame cycle.

43. A means for producing a high speed 3D image comprising:
a monochromatic sensor means for receiving a reflected light pattern reflected from an object;
a plurality of optical pattern filter means for capturing two or more separate sequential images of said object; and
optical pattern combination means for generating a single frame image of said object based on said reflected light pattern, said frame being equivalent in quality to that of a Rainbow type image of said object.

44. The means for producing a high speed 3D image of claim 43, further comprising a monochromatic light projecting means for generating three variable intensity monochromatic pattern sequences that are similar to the spectral characteristics of said monochromatic sensor means.

45. The means for producing a high speed 3D image of claim 44, wherein said means for producing a high speed 3D image is configured to capture said three separate sequential images of said object within a single frame cycle.

46. The means for producing a high speed 3D image of claim 45 wherein said monochromatic sensor means comprises:
a 3-chip CCD sensor having independent red, green, and blue channels; and
a plurality of timing trigger circuits communicatively coupled to said 3-chip CCD sensor, wherein said plurality of timing trigger circuits are configured to generate separate independent expose trigger signals associated with a red, a green, and a blue trigger signal of said light projecting means.

47. The means for producing a high speed 3D image of claim 46, wherein said monochromatic light projecting means further comprises a high speed electronically controllable shutter.

48. The means for producing a high speed 3D image of claim 46, wherein said timing trigger circuits are configured to eliminate crosstalk between said red, green, and blue channels.

49. The means for producing a high speed 3D image of claim 43, wherein said monochromatic sensor means comprises a plurality of near infrared (NIR) CCD sensors.

50. The means for producing a high speed 3D image of claim 49, further comprising a NIR light projection means for projecting NIR light onto said object.

51. A method for producing a high speed image comprising:
illuminating an object with light having a variable intensity patterns;
imaging said illuminated object with a monochromatic imaging sensor; and
calculating a distance to a point on said object using triangulation based on a baseline distance between said light source and said camera, an angle between said camera and said baseline, and an angle at which light striking the point is emitted by said light source as determined from an intensity of a light striking said point.

52. The method of claim 51, wherein said illuminating further comprises generating sequential color projections onto said object; wherein said sequential light projections are produced by one of a rotatable color wheel, a deformable mirror, or a sequential RGB light emitting diode array.

53. The method of claim 51, wherein said illuminating further comprises illuminating said object with near infrared (NIR) light.

54. The method of claim 53, wherein said imaging comprises imaging said illuminated object with an NIR CCD camera.

55. The method of claim 51, further comprising synchronizing said illumination and said imaging to eliminate crosstalk between different color channels.

56. The method of claim 55, wherein said synchronizing said illumination and said imaging comprises:
generating an independent illumination; and
independently triggering the exposure of a monochromatic sensor disposed within said monochromatic imaging sensor, wherein said independent triggering is synchronized with said illumination.

57. The method of claim 56, further comprising synchronizing said illumination and said imaging to image said object within a single frame cycle.

58. The method of claim 5 1, further comprising:
sequentially projecting red, green, and blue light on said object;
imaging said illuminated object with said monochromatic imaging sensor, thereby acquiring three sequential images of said object; and
generating a single two-dimensional color image from said three sequential images.

59. The method of claim 51, further comprising:
illuminating an object with light having a variable intensity patterns;
imaging said illuminated object with a plurality of monochromatic CCD cameras to acquire multiple images of said object from a plurality of views, wherein each of said cameras using different bandwidths; and
combining said multiple images to form a full coverage three-dimensional image of said object.

60. A 3D camera comprising:
a plurality of monochromatic sensors disposed around an object; and
a plurality of monochromatic light projectors associated with said plurality of monochromatic sensors;
wherein each of said monochromatic sensors is configured to capture images of said object while operating in a unique spectrum band;
said camera being configured to simultaneously acquire a multi-view 3D image of said object.

61. The 3D camera of claim 60, further comprising a computing device communicatively coupled to said camera, wherein said computing device further comprises a mosaic means configured to combine said images to form a multi-view 3D image of said object.

62. The 3D camera of claim 61, wherein said monochromatic sensors comprise charge-coupled device (CCD) sensors, each sensor including a matched narrow-band spectral filter disposed in front of said CCD sensor.

63. The 3D camera of claim 60, wherein each of said plurality of monochromatic light projectors projects light in a unique spectrum band corresponding to one of said monochromatic sensors.

64. The 3D camera of claim 63, wherein each of said plurality of monochromatic light projectors is configured to project NIR light, and said monochromatic sensors comprise NIR CCD cameras.
